(19) United States
(12) Patent Application Publication
(10) Pub. No.: US 2006/0215545 A1
(43) Pub. Date: Sep. 28, 2006

(54) Controlling loss of signal thresholds in an optical receiver

(76) Inventor: Stephen T. Nelson, Cupertino, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/385,414

(22) Filed: Mar. 21, 2006

Related U.S. Application Data
(60) Provisional application No. 60/664,015, filed on Mar. 22, 2005.

(51) Int. Cl. H04J 1/16

(52) U.S. Cl. 370/216; 398/162

(57) ABSTRACT

Systems and methods for programming a loss of signal (“LOS”) threshold level relating to the receipt of optical signals by an optical receiver are disclosed. By the present invention, the LOS threshold level can be dynamically programmed and adjusted during operation of the optical receiver according to the data rate of the received optical signal. This in turn provides improved optical signal reception characteristics for the receiver. In one embodiment, an optical receiver system having a programmable LOS threshold level is disclosed, comprising an optical receiver that receives an optical signal, a photodetector that senses receive power of the optical signal, a memory location containing a plurality of programmed LOS threshold levels, a processor that selects one of the programmed LOS threshold levels according to an input signal received by the processor, and a comparator that compares the optical signal receive power with the programmed LOS threshold levels.

### CROSS-REFERENCE TO RELATED APPLICATIONS

This application claims the benefit of U.S. Patent Application No. 60/664,015, entitled “OPTICAL TRANSCEIVER MODULE HAVING AN ADJUSTABLE LOSS OF SIGNAL THRESHOLD SETTING,” filed on Mar. 22, 2005, which is incorporated herein by reference in its entirety.

### BACKGROUND

1. Technology Field

The present invention generally relates to optical receivers, such as those found in optical transceiver modules. In particular, the present invention relates to an optical receiver that can dynamically set and adjust loss-of-signal threshold levels according to the data rate of an optical signal received by the optical receiver.

2. The Related Technology

In optical data transmission networks, optical signal reception sensitivity 04 specifications for an optical receiver are defined for a given physical interface specification, such as FibreChannel (“FC”), gigabit Ethernet (“GbE”), according to the data rate of the optical signal. As such, it can be determined when the receive power of an optical signal received by the optical receiver has fallen below accepted parameters, according to the particular sensitivity specification. When such a situation occurs, the optical receiver can issue a “loss of signal” (“LOS”) alert to notify a host system operably connected to the optical receiver that the relative strength of the received optical signal is such that correct transmission of the data contained in the optical signal may be interrupted. If such an alert is received, the host system can then initiate corrective procedures to rectify the problem condition.

During optical network data transmission activities, optical signals can be received by the host system via the optical receiver at multiple data transmission frequencies, or data rates. Examples of such data rates include one, two, four, eight or even ten gigabits (“Gbit”)/second. An optical signal received at a particular data rate is typically assigned a threshold level below which an LOS alert will be issued by the optical receiver to indicate an excessively low receive power for the signal. For instance, an optical signal having a data rate of 1 Gbit/sec. can be assigned an LOS threshold level of about −20 dB, a signal transmitted at a 4 Gbit/sec. data rate can have a −15 dB LOS threshold level, and a signal having a data rate of 8 Gbit./sec. can have a −12 dB LOS threshold level, according to the particular sensitivity specification. Thus should the receive power of a 4 Gbit/sec. optical signal fall below its LOS threshold of about −15 dB in this instance, an LOS alert will be sent by the optical receiver to the host.

Many optical receivers, such as those employed in optical transceiver modules, now employ multi-data rate technology, wherein the receiver can accommodate the receipt of optical signals having respectively different data rates. However such modules have typically been capable of defining, via factory setting, only a single LOS threshold level. This can undesirably result in the host system being warned via an LOS alert either too early or too late with respect to an optical signal having an insufficient receive power.

In light of the above, a need exists in the art for an optical receiver that can accommodate for the receipt of optical signals having varying data rates and dynamically adjust the LOS threshold level according to the respective optical signal, thereby providing a timely alert to a host system in the interest maintaining proper receive power levels for the optical signal. In particular, any solution should be able to accommodate optical signals having elevated data rates currently used or forecast to be employed in the future, including 8 and 10 Gbits/sec. Further, any solution should permit the assignment of an LOS alert level at or near the sensitivity level of the transceiver module so as to prevent alerting of an LOS condition either too early or too late.

### BRIEF SUMMARY

The present invention has been developed in response to the above and other needs in the art. Briefly summarized, embodiments of the present invention are directed to systems and methods for dynamically adjusting a loss of signal (“LOS”) threshold level relating to an optical signal received by an optical receiver. Dynamic LOS threshold adjustment made possible by the present invention accommodates optical receivers that are employed in implementations where multiple optical signals having different data rates may be received. This in turn ensures that the receive power of an optical signal is properly associated with a corresponding LOS threshold level during optical signal receipt by the optical receiver.

In one embodiment, an optical receiver system having a programmable LOS threshold level is disclosed, comprising an optical receiver that receives an optical signal, a photodetector that senses receive power of the optical signal, a memory location containing a plurality of programmed LOS threshold levels, a processor that selects one of the programmed LOS threshold levels according to an input signal received by the processor, and a comparator that compares the optical signal receive power with the programmed LOS threshold levels.

In another embodiment, an optical receiver system having a programmable loss of signal threshold level is disclosed, comprising an optical receiver that receives an optical signal, a photodetector that senses a receive power of the optical signal, a control module including both a register that contains a plurality of programmed loss of signal threshold settings and a processor. The processor contains microcode that, when executed, causes the processor to execute the following: in response to an input signal relating to a data rate of the optical signal, select from a register one of a plurality of loss of signal threshold settings, and forward the selected loss of signal threshold setting to a comparator that compares the selected loss of signal threshold setting to the sensed optical signal receive power. In yet another embodiment, a method for providing a loss of signal indication relating to an optical signal received by an optical transceiver module is disclosed comprising accessing an input signal relating to a data rate of the optical signal, assigning a loss of signal threshold level according to the data rate, comparing a receive power of the optical signal with the assigned loss of signal threshold level to determine if a loss of signal condition exists, and if a loss of signal condition exists, transmitting a loss of signal alert to a host system.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an optical transceiver module that is configured in accordance with embodiments of the present invention;

FIG. 2 is a simplified block view showing various aspects of the optical transceiver module of FIG. 1;

FIG. 3 is a simplified block view of an integrated circuit control module included in the optical transceiver module shown in FIG. 2;

FIG. 4 is a simplified block view of the optical transceiver module of FIG. 2, showing various components of an LOS assignment system, according to one embodiment of the present invention;

FIG. 5A is a simplified block view including various components of an LOS assignment system, according to another embodiment;

FIG. 5B is a simplified block view of portions of an LOS assignment system, according to yet another embodiment;

FIG. 6 is a simplified block view including various components of an LOS assignment system, according to one embodiment; and

FIG. 7 is a simplified block view including various components of an LOS assignment system, according to yet another embodiment.

### DETAILED DESCRIPTION OF SELECTED EMBODIMENTS

Reference will now be made to figures wherein like structures will be provided with like reference designations. It is understood that the drawings are diagrammatic and schematic representations of exemplary embodiments of the invention, and are not limiting of the present invention nor are they necessarily drawn to scale.

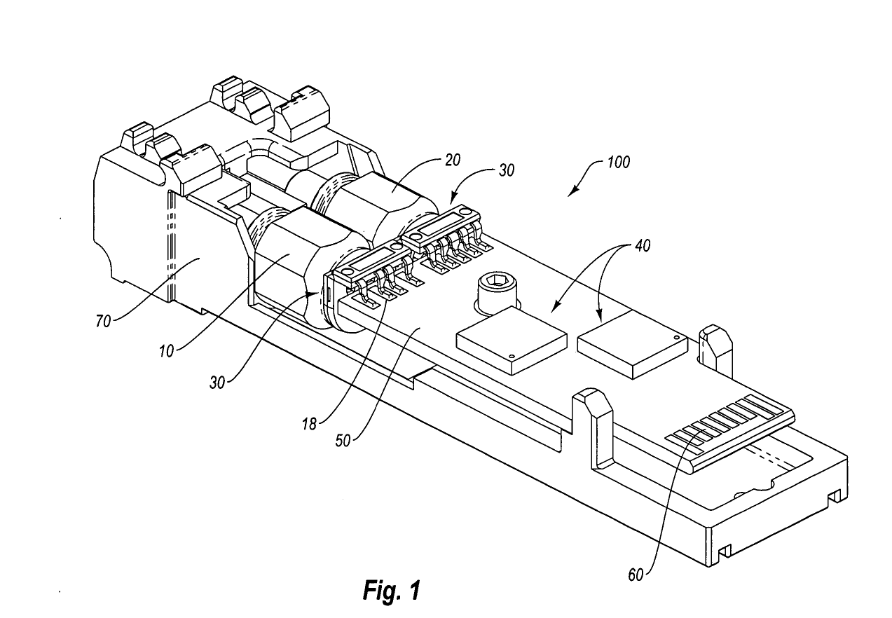

FIGS. 1-6 depict various features of embodiments of the present invention, which is generally directed to systems and methods for dynamically adjusting loss of signal threshold levels relating to an optical signal received by an optical receiver. This in turn enables the LOS threshold level to properly relate to the data rate of the received optical signal, which data rate may change over time during signal reception operations by the optical receiver.

In the exemplary embodiment, the optical receiver is embodied as a receiver optical subassembly (“ROSA”) of an optical transceiver module (“transceiver”). The ROSA, together with a transmitter optical subassembly (“TOSA”) of the transceiver, includes various components to enable the reception and transmission of optical signals to and from a host system that is operably connected to the transceiver. The host system can be included as a node in an optical communications network, for instance, and can employ the transceiver in communicating via optical signals with other components of the network. Note, however, that the discussion to follow regarding embodiments of the present invention as they relate to dynamically adjusting LOS thresholds in a transceiver should not be construed as limiting the present invention to only such embodiments. Indeed, it is appreciated that principles of the present invention can extend to optical receivers employed in other configurations as well.

1. Exemplary Operating Environment

Reference is first made to FIG. 1, which depicts a perspective view of an optical transceiver module (“transceiver”), generally designated at 100, for use in transmitting and receiving optical signals in connection with an external host that is operatively connected in one embodiment to a communications network (not shown). As depicted, the transceiver shown in FIG. 1 includes various components, including an optical receiver implemented as a receiver optical subassembly (“ROSA”) 10, a transmitter optical subassembly (“TOSA”) 20, electrical interfaces 30, various electronic components 40, and a printed circuit board 50. In detail, two electrical interfaces 30 are included in the transceiver 100, one each used to electrically connect the ROSA 10 and the TOSA 20 to a plurality of conductive pads located on the PCB 50. The electronic components 40 are also operably attached to the PCB 50. An edge connector 60 is located on an end of the PCB 50 to enable the transceiver 100 to electrically interface with a host (not shown here). As such, the PCB 50 facilitates electrical communication between the ROSA 10/TOSA 20, and the host. In addition, the above-mentioned components of the transceiver 100 are partially housed within a housing portion 70. Though not shown, a shell can cooperate with the housing portion 70 to define a covering for the components of the transceiver 100.

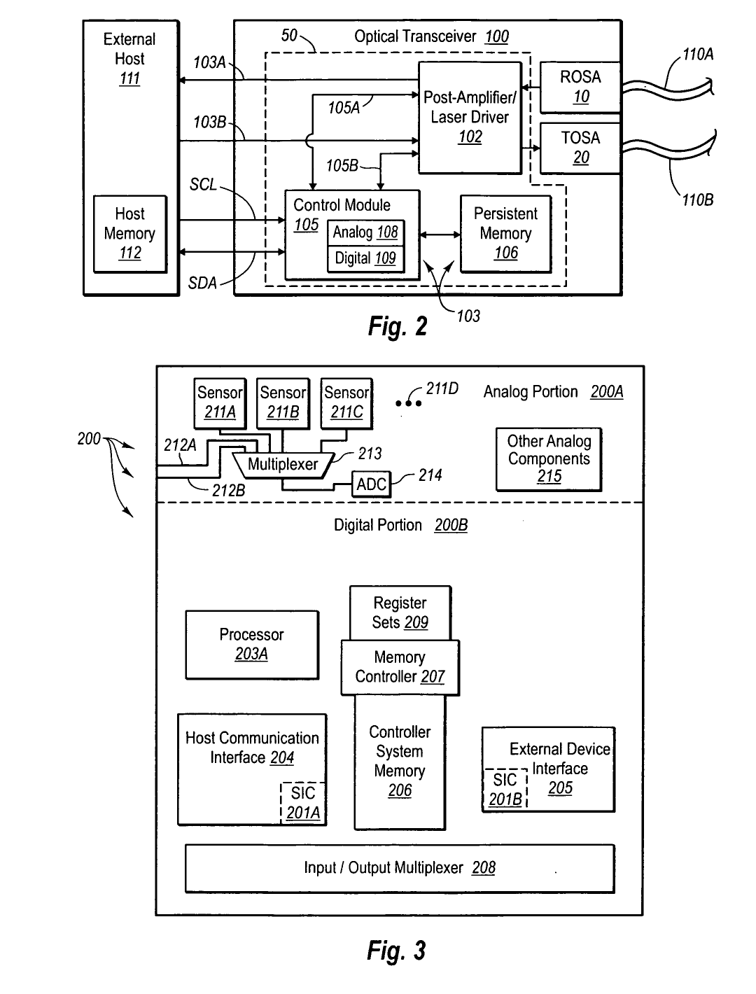

Reference is now made to FIG. 2, which is a simplified block diagram of the transceiver 100 of FIG. 1, depicting various physical and operational aspects thereof. While the optical transceiver 100 will be described in some detail, the optical transceiver 100 is described by way of illustration only, and not by way of restricting the scope of the invention. As mentioned above, the optical transceiver 100 in one embodiment is suitable for optical signal transmission and reception at a variety of per-second data rates, including 1, 2, 4, 8, 10 Gbit, or higher bandwidth fiber optic links. Furthermore, the principles of the present invention can be implemented in optical transceivers of any form factor such as XFP, SFP and SFF, without restriction.

In operation, the optical transceiver 100 receives an optical signal from a fiber 110A via the ROSA 10 in manner to be described more fully below. The ROSA 10 acts as an opto-electric transducer by transforming the received optical signal into an electrical signal. The ROSA 10 provides the resulting electrical signal to a post-amplifier. In the illustrated embodiment, the post amplifier is consolidated with a laser driver as an integrated post amplifier/laser driver (“PA/LD”) 102. As such, the PA/LD 102 resides on a single integrated circuit chip and is included as a component, together with the other electronic components 40, some of which are further described below, on the printed circuit board (“PCB”) 50. Further details regarding the integrated PA/LD 102 can be found in U.S. patent application Ser. No. 10/970,529, entitled “Integrated Post Amplifier, Laser Driver, and Controller,” filed Oct. 21, 2004 (the “'529 application”), which is incorporated herein by reference in its entirety. In other embodiments, the post amplifier and laser driver can be included as separate components on the PCB 50.

The post-amplifier portion of the PA/LD 102 amplifies the electrical signal and provides the amplified signal to an external the host 111 as represented by arrow 102A. The external host 111 may be any computing system capable of communicating with the optical transceiver 100. The external host 111 may contain a host memory 112 that may be a volatile or non-volatile memory source. In one embodiment, some components of the optical transceiver 100 can reside on the host 111 while the other components of the transceiver reside on the printed circuit board 50 separate from the host.

The optical transceiver 100 may also receive electrical signals from the host 111 for transmission onto a fiber 110B. Specifically, the laser driver portion of the PA/LD 102 receives the electrical signal as represented by the arrow 102B, and drives a laser within the TOSA 20 with signals that cause the TOSA to emit onto the fiber 110B optical signals representative of the information in the electrical signal provided by the host 111. Accordingly, the TOSA 20, which corresponds to the TOSA shown in FIG. 1B, serves as an electro-optic transducer.

The behavior of the ROSA 10, the PA/LD 102, and the TOSA 20 may vary dynamically due to a number of factors. For example, temperature changes, power fluctuations, and feedback conditions may each affect the performance of these components. Accordingly, the transceiver 100 includes a control module 105, which may evaluate environmental conditions, such as temperature, and/or operating conditions, such as voltage, and receive information from the post-amplifier portion of the PA/LD 102 (as represented by arrow 105A) and from the laser driver portion of the PA/LD (as represented by arrow 105B). This allows the control module 105 to optimize the dynamically varying performance, and additionally detect when there is a loss of signal, as will be described in greater detail below. The control module 105, the post-amplifier 102, and the laser driver 103 may be the same chip, as disclosed in the '529 application. Alternatively, they may be distributed across two or more chips on the PCB 50.

Specifically, the control module 105 may optimize the operation of the transceiver 100 by adjusting settings on the PA/LD 102 as represented by the arrows 105A and 105B. These settings adjustments can be intermittent and made when temperature or voltage or other low frequency changes so warrant, or can be periodically performed in accordance with a scheduled pattern.

The control module 105 may have access to a persistent memory 106, which in one embodiment, is an electrically erasable and programmable read only memory (“EEPROM”). Persistent memory 106 may also be any other non-volatile memory source. The persistent memory 106 and the control module 105 may be packaged together in the same package or in different packages without restriction.

Data and clock signals may be provided from the host 111 to the control module 105 using the serial clock line SCL, and the serial data line SDA. Also, data may be provided from the control module 105 to the host 111 using serial data signal SDA to allow for transmitting diagnostic data such as environmental and/or operational parameters. The control module 105 includes both an analog portion 108 and a digital portion 109. Together, they allow the control module to implement logic digitally, while still largely interfacing with the rest of the optical transceiver 100 using analog signals.

As used herein, the term “diagnostic data” will refer to both environmental parameters and operational parameters, whether the parameter is provided as raw data or processed data. Diagnostic data can be provided in analog or digital form. The environmental parameter may be, for example, supply voltage, humidity, acceleration, ambient light levels, ambient vibration, magnetic flux intensity, or any other environmental parameter that may affect the performance of an optoelectronic device and that may be compensated for by suitable adjustment of one or more operational parameters. Environmental parameters may also be independent of the operation of the optoelectronic device, but may, nevertheless, affect operational parameters. Operational parameters can include statistical information such as, for example, a total operational time, an average operational time between boots, a total number of error conditions encountered, an identification of one or more error conditions encountered, a categorization of the number of error conditions encountered for a plurality of different error types, a number of times the optical transceiver has been booted, or the like. Operational parameters also include, for example, a laser wavelength approximation, a laser temperature measurement, a supply voltage measurement, a transceiver temperature measurement, a laser bias current measurement, a Thermo Electric Cooler (“TEC”) current measurement, a transmit power measurement, a receive power measurement, an acceleration measurement, a peak acceleration measurement, or the like.

FIG. 3 schematically illustrates an exemplary configuration 200 of the control module 105 in further detail. The control module 200 includes an analog portion 200A that represents an example of the analog portion 108 of FIG. 2, and a digital portion 200B that represents an example of the digital portion 109 of FIG. 2. For example, the analog portion 200A may contain digital-to-analog converters, analog-to-digital converters, high speed comparators (e.g., for event detection), voltage-based reset generators, voltage regulators, voltage references, clock generator, and other analog components, generally designated at 215. For example, the analog portion includes sensors 211A, 211B, 211C amongst potentially others as represented by the horizontal ellipses 211D. Each of these sensors may be responsible for measuring environmental and/or operational parameters that may be measured from the control module 200 such as, for example, supply voltage and transceiver temperature. The control module may also receive external analog or digital signals from other components within the optical transceiver. Two external lines 212A and 212B are illustrated for receiving such external analog signals although there may be many of such lines.

The internal sensors 211A through 211D may generate analog signals that represent the measured values. In addition, the externally provided signals 212A, 212B may also be analog signals. In this case, the analog signals are converted to digital signals so as to be available to the digital portion 200B of the control module 200 for further processing. Of course, each analog parameter value may have its own analog-to-digital converter (“ADC”). However, to preserve chip space, each signal may be periodically sampled in a round robin fashion using a single ADC such as the illustrated ADC 214. In this case, each analog value may be provided to a multiplexer 213, which selects in a round robin fashion, one of the analog signals at a time for sampling by the ADC 214. Alternatively, multiplexer 213 may be programmed to allow for any order of analog signals to be sampled by ADC 214.

As previously mentioned, the analog portion 200A of the control module 200 may also include other analog components 215 such as, for example, digital to analog converters, other analog to digital converters, high speed comparators (e.g., for event detection), voltage-based reset generators, voltage regulators, voltage references, clock generators, and other analog components. The high speed comparators may be supplied with one input from an internal sensor or from an external line to receive a measured parameter value. The other input to the comparator may be a comparison value. Should the measured parameter value exceed the comparison value, the comparator may generate a logical high (or low), which indicates that the event has occurred. For example, suppose that the standard maximum transceiver temperature is 85 degrees Celsius. The actual measured transceiver temperature may be provided as one input to a comparator, while a value representing 85 degrees Celsius is provided to the other input of the comparator. In this way, parameter comparison can be performed.

A general-purpose processor 203A is also included. The processor recognizes instructions that follow a particular instruction set, and may perform normal general-purpose operation such as shifting, branching, adding, subtracting, multiplying, dividing, Boolean operations, comparison operations, and the like. In one embodiment, the general-purpose processor 203A is a 16-bit processor and may be identically structured. The precise structure of the instruction set is not important to the principles of the present invention as the instruction set may be optimized around a particular hardware environment, and as the precise hardware environment is not important to the principles of the present invention.

A host communications interface 204 is used to communicate with the host 111 using the serial data (“SDA”) and serial clock (“SCL”) lines and the serial data line SDA of the optical transceiver 100. The external device interface 205 is used to communicate with, for example, other modules within the optical transceiver 100 such as, for example, the post-amplifier/laser driver 102, or the persistent memory 106.

The internal controller system memory 206 (not to be confused with the external persistent memory 106) may be Random Access Memory (“RAM”) or non-volatile memory. The memory controller 207 shares access to the controller system memory 206 amongst the processor 203A and with the host communication interface 204 and the external device interface 205.

In one embodiment, the host communication interface 204 includes a serial interface controller 201A, and the external device interface 205 includes a serial interface controller 201B. The two serial interface controllers 201A and 201B may communicate using a two-wire interface such as I²C or may be another serial interface so long as the interface is recognized by both communicating modules. One serial interface controller (e.g., serial interface controller 201B) is a master component, while the other serial interface controller (e.g., serial interface controller 201A) is a slave component.

An input/output multiplexer 208 multiplexes the various input/output pins of the control module 200 to the various components within the control module 200. This enables different components to dynamically assign pins in accordance with the then-existing operational circumstances of the control module 200. Accordingly, there may be more input\output nodes within the control module 200 than there are pins available on the control module 200, thereby reducing the footprint of the control module 200.

Having described a specific environment with respect to FIGS. 1-3, it will be understood that this specific environment is only one of countless architectures in which the principles of the present invention may be employed. As previously stated, the principles of the present invention are not intended to be limited to any particular environment.

Referring to FIGS. 2 and 3, control module 200, which is an exemplary implementation of the control module 105 shown in FIG. 2, executes microcode received from a source. Specifically, processor 203A loads microcode from the source into the controller system memory 206. While system memory may be RAM, it may also be a processor, register, flip-flop or other memory device. For example, the processor 203 may load microcode stored in persistent memory 106 into controller system memory 206. The microcode from persistent memory 106 may include functions that direct which operational parameters to measure. Alternatively, the microcode may be provided by the external host 111, delivered to control module 105 over serial data line SDA. For example, external host memory 112 may contain a library of different microcode functions. A user is thus able to interface with host 111 and choose which microcode function to run based on the desired parameters to measure. In addition, external host 111 may be connected to the Internet or some other wide area network, allowing processor 203A to acquire microcode from a remote source. This connection can be achieved by any standard internet or wide area network protocol.

2. Dynamic Loss of Signal Threshold Adjustment

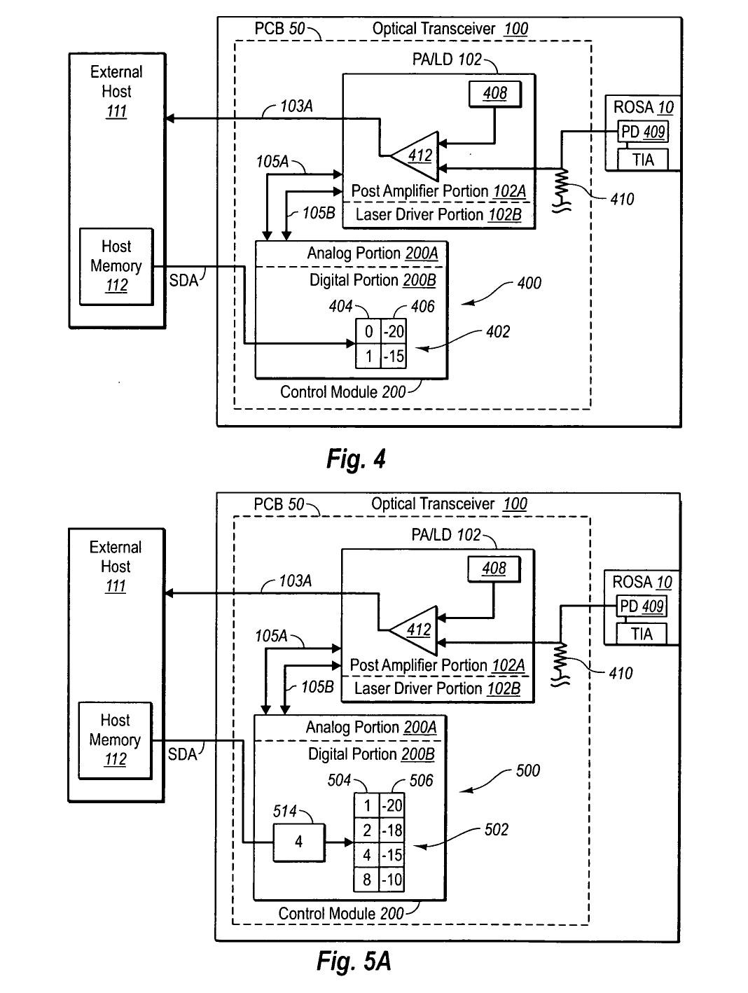

Together with FIGS. 1-3, reference is now made to FIG. 4. In general, the operating environment described above, including the transceiver 100, is exemplary of one environment in which principles of the present invention can be practiced. In particular, embodiments of the present invention enable dynamic programming of loss of signal (“LOS”) threshold settings in response to varying data rates of optical signals received by an optical receiver, such as the ROSA 10 of the transceiver 100 in the present embodiment. This enables the optical receiver to properly link a suitable LOS threshold setting with the current data rate of the optical signal, thereby enabling an LOS alert signal to be forwarded to the host under the appropriate conditions relating to a loss of signal event. Correspondingly, this prevents premature or delayed LOS alerting to the host as a result of a static, factory set LOS threshold setting in known optical receivers.

In brief, standards bodies, such as T11 and IAAA, specify sensitivity specifications for the receipt of optical signals by an optical receiver, according to the particular physical interface specification, including FC and GbE physical interfaces. These sensitivity specifications can be used to define desired LOS threshold settings according to the particular data rate of the received optical signal. Thus, the LOS threshold represents a minimum power level of the received optical signal that is considered adequate for reception by the optical receiver and use by the host system. If the receive power level falls below the LOS threshold, a condition known as loss-of-signal (“LOS”) is encountered. In such a case, a signal can be generated to alert the host that an LOS condition is present, indicating that the power level of the received optical signal is below the threshold of acceptable standards for proper optical communication, thereby enabling the host to execute corrective procedures to restore the received optical signal to proper power level parameters for the resumption of proper optical communication.

As mentioned, distinct LOS threshold levels are desired for optical signals having different data rates. This is significant, given the fact that optical receivers are often configured to receive optical signals having one of a variety of data rates, such as 1, 2, 4, 8, or 10 Gbit/sec. Accordingly, as the data rate of optical signals received by the transceiver change, the LOS threshold level desirably should also change, in order to provide an accurate indication of whether the received optical signal has an adequate power level for sufficient optical communication. As such, in accordance with one embodiment of the present invention, the transceiver 100 as detailed herein is configured to enable the programmable adjustment of the LOS threshold level during optical receiver operation according to the particular data rate of the optical signal that is received.

FIG. 4 shows an LOS assignment system, generally designated at 400, for enabling the programming of an LOS threshold setting for an optical receiver, such as the ROSA 10 included in transceiver 100, according to one embodiment. In detail, the LOS assignment system 400 includes various components configured as, or in connection with, various of the components of the transceiver 100 and/or the control module 200 described above in connection with FIGS. 2 and 3, as will be seen.

The LOS assignment system 400 first includes an LOS table 402 including a plurality of memory locations, such as registers, for storing data relating to LOS threshold settings. In particular, the LOS table 402 includes a rate select portion 404 and a threshold setting portion 406. The rate select portion 404 includes data relating to possible data rates of an optical signal to be received by the ROSA 10. In particular, the rate select portion 404 stores two values in the present embodiment: a logical “0” indicating a relatively lower (“low”) data rate, and a logical “1” indicating a relatively higher (“high”) data rate. The threshold setting portion 406 stores threshold setting values that respectively correspond to the low and high data rates stored in the rate select portion 404. As shown, the threshold setting portion 406 stores a threshold setting value of −20 dB for the low data rate, and −15 dB for the high data rate. The values stored in the threshold setting portion 406 thus relate to the desired threshold setting to be assigned in determining whether an LOS condition is present for an optical signal received by the ROSA 10 having either the low or high data rate.

The LOS table 402 in one embodiment is included as a register in the register sets 209 in the digital portion 200B of the control module 200, shown in FIG. 3. In other embodiments, the LOS table can be found in the controller system memory 206 of the control module 200, or in another suitable location of the control module.

The values stored in the LOS table 402 can be pre-set at the time of control module manufacture, or can be programmed post-manufacture by acceptable register/system memory programming methods. The host 111 in the present embodiment provides instructions for selecting the high or low data rate entry in the rate select portion 404 via an input signal transmitted by the SDA line and an MSA-defined rate select pin interface existing between the host and the control module 200 to the processor 203A, which selects the data rate from the rate select portion 404 of the LOS table 402. Other possible host-control module interfaces include an I²C line.

Once the data rate (i.e., low or high data rate) is selected from the LOS table rate select portion 404 by the processor 203A according to host instructions, the corresponding LOS threshold setting corresponding to the selected data rate is forwarded, in one embodiment, via the external device interface 205 and signal lines indicated at 105A or 105B, from the threshold setting portion 406 of the LOS table 402 to an LOS setting register 408, which stores the value for use by a comparator 412. As is the case with many of the communications between the control module 200 and the PA/LD 102, the LOS threshold setting can be converted from a digital value, as stored in the LOS table 402, to an analog signal suitable for receipt by the LOS setting register 408. This conversion can be achieved by a digital-to-analog converter located in the control module 200, PA/LD 102, or other suitable location in the transceiver 100.

In the present embodiment, the LOS setting register 408 is located in the post amplifier portion 102A of the PA/LD 102, as is the comparator 412. The comparator 412 receives as input both the LOS threshold setting stored by the LOS setting register 408 and an input signal relating to the receive power of an optical signal received by a photodetector 409 of the ROSA 10. In the present embodiment, the photodetector 409 is a photodiode, and the input signal relating to the receive power is provided by a resistor 410 that is in operable communication with the photodiode.

In brief, an optical signal received by the photodetector 409 is converted by the photodetector into a current signal that is proportional to the receive power of the optical signal. The resistor 410 is used to convert the current signal received from the photodetector 409 to a voltage signal. This voltage signal is then fed as one input into the comparator 412, while a voltage signal corresponding to the LOS threshold setting stored by the LOS setting register 408 is fed into the comparator as a second input. Comparison of these two inputs allows the comparator 412 to determine whether the receive power of the optical signal is above or below the LOS threshold setting.

If the optical signal receive power is below the LOS threshold setting, an LOS alert signal can be forwarded to the host 111 by the comparator 412 via the signal line indicated at 103A, or other suitable communication interface. In one embodiment, the LOS alert signal is a digital high voltage signal, as opposed to a digital low voltage signal that indicates that the optical signal receive power is desirably above the LOS threshold setting. The comparator 412 in one embodiment provides a continuous signal to the host 111, indicating either a digital high or low signal, during its comparison activities. In another embodiment, the comparator 412 can be configured to send a signal only when an LOS status is encountered.

It is appreciated that the processor 203A can be involved in the execution of one or more of the steps outlined above, in addition to what has already been discussed. Also, though the embodiments discussed herein focus on use of an analog comparator in determining when an LOS status exists, in another embodiment, this process could be performed digitally. For instance, an analog signal relating to the light level received by the photodetector could be converted to a digital signal by an analog-to-digital converter. This digital signal could then be compared by the processor to a threshold level stored in system or persistent memory, or in a dedicated register set of the control module, to determine where an LOS status is present. Thus the present process can be practiced in a variety of ways.

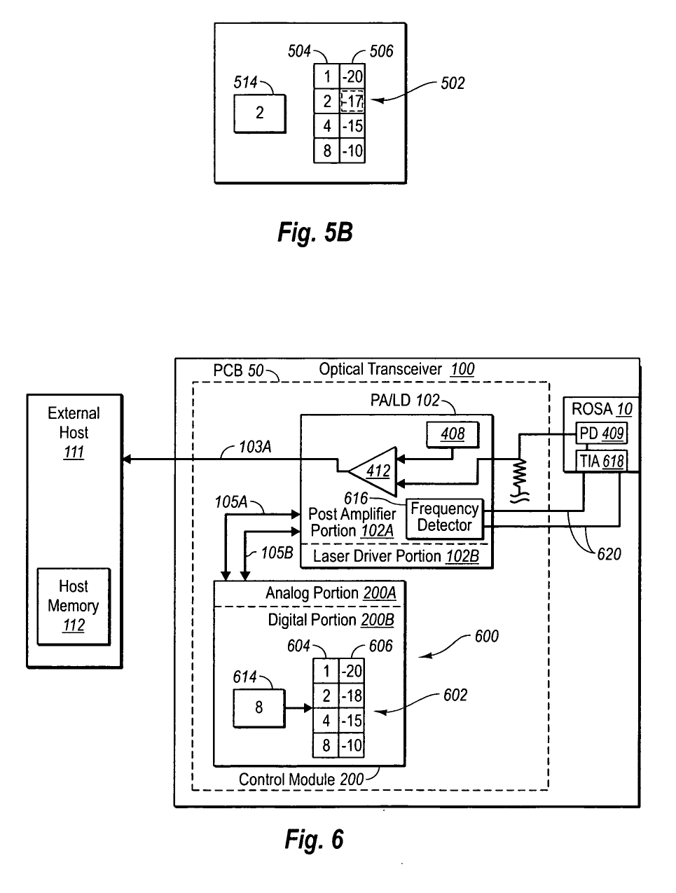

Reference is now made to FIG. 5A, which depicts various details regarding an LOS assignment system, generally designated at 500, configured as a portion of the transceiver 100, according to another exemplary embodiment. Before discussing this embodiment in detail, it is noted that various components are shared by this and other embodiments discussed herein. As such, only selected features of the present embodiment will be discussed. This notwithstanding, several of the features to be disclosed with respect to this or any of the other embodiments herein can be applied to the other embodiments as well.

As with the previous embodiment, the LOS assignment system 500 includes an LOS table 502 as a register in the digital portion 200B of the control module 200. The LOS table further includes a data rate portion 504 and a threshold setting portion 506. In contrast to the previous embodiment, the LOS table 502 is expanded in size, having four entries in both the data rate portion 504 and the threshold setting portion 506. In particular, the data rate portion 504 includes values relating to four different possible data rates at which rate data contained in an optical signal can be received by the ROSA 10. For instance, value “1” in the data rate portion can represent a data rate of 1 Gbit/sec., “2” represents 2 Gbit/sec., “4” represents 4 Gbits/sec., and “8” represents 8 Gbits/sec. Correspondingly, the threshold setting portion 506 includes values, e.g., −20, −18, −15, −10 dBm, respectively, indicating the LOS threshold settings that are assigned to each of the data rates included in the data rate portion of the LOS table 502. As before, the LOS table 502 can be included in one or more of the register sets 209, or in the controller system memory 206, of the control module digital portion 200B. Moreover, in other embodiments, the size of the LOS table can be expanded or decreased to accommodate any suitable number of data rates that might be encountered by the ROSA 10 of the transceiver 100.

The LOS table 502 described above can be utilized by the host 111 in selecting the proper data rate of the optical signal to be received by the transceiver ROSA 10. In particular, a data rate register 514 is established in the control module digital portion 200B or other suitable location in the transceiver 100, and is put into communication with the host 111 via the SDA signal line or other suitable signal line. The host 111 can then assign the optical signal data rate by forwarding an input signal containing the corresponding data rate value to'the data rate register 514. Via the processor 203A, the LOS table 502 is consulted to determine the value of the LOS threshold setting that pertains to the value assigned by the host 111 to the data rate register 514. In the illustrated embodiment, for instance, the host 111 has assigned the value “4” to the data rate register 514, indicating that the date rate of the optical signal to be received by the ROSA 10 is 4 Gbits/sec. Reference to the LOS table 502 will indicate that that threshold level setting pertaining to a data rate of 4 Gbits/sec. is −15 dB, as seen in the threshold setting portion 506. This value is then forwarded by the control module in the manner previously described above to the LOS setting register of the PA/LD 102 in order to enable the comparator to determine whether an LOS condition exists with respect to the receive power of the received optical signal, as already explained.

FIG. 5B describes a variation of the embodiment depicted and described in connection with FIG. 5A, wherein the host 111 not only can assign the data rate value to be retained in the data rate register 514, but can also assign the values contained in the LOS table 502. For instance, and as shown in FIG. 5B, the host can assign a particular value, such as −17 dB, to the threshold setting portion location corresponding to a data rate of 2 Gbits/sec.

Note that the data rate of an optical signal received by the ROSA 10 can change during operation of the transceiver 100. In such a case, the host 111 can send a new value to the data rate register and/or the LOS table 502 to accommodate the new data rate or other condition requiring value modification. Note also that in one embodiment an entity or device other than the host can assign values to the data rate register or LOS table. Further, it is appreciated that the values and particular structure of the LOS table and data rate register are exemplary only; other values and register configurations can be employed while still residing within the claims of the present invention.

Reference is now made to FIG. 6, showing the transceiver 100 and ROSA 10 having an LOS assignment system according to yet another exemplary embodiment. In detail, FIG. 6 depicts the transceiver 100 configured with functionality to enable the transceiver to detect the data rate of an optical signal received by the ROSA 10, as will be described.

Similar to the previous embodiments, the LOS assignment system 600 includes an LOS table 602 having a data rate portion 604 and a threshold setting portion 606. A data rate register 614 is also included with the aforementioned components in the digital portion 200B of the control module 200.

In the illustrated embodiment, a frequency detector 616 is included in the post amplifier portion 102A of the PA/LD 102. The frequency detector 616 is operably attached to a trans impedance amplifier (“TIA”) 618 of the ROSA 10 via two differential signal lines 620. The TIA 618 in turn is operably connected to the photodetector 409 to produce an electrical differential signal containing the data transmitted via the optical signal received by the ROSA 10. The differential signal is transmitted via the signal lines 620 to the frequency detector 618, which analyzes the data stream contained therein to determine the data rate of the received optical signal. Alternatively, other components can be utilized by one skilled in the art to autonomously determine the data rate of the received optical signal. Hence, the frequency detector 616 depicted in FIG. 6 is merely exemplary of a range of frequency detection equipment that can be employed with respect to the transceiver 100.

Data rate information obtained by the frequency detector 616 during operation of the transceiver 100 is forwarded to the data rate register 614 of the control module 200 as an input signal via signal lines indicated at 105A and 105B and the external device interface 205. The data rate register 614 saves the data rate value, enabling the processor 203A to consult the LOS table 602 to determine the applicable LOS threshold setting, using the data rate portion 604 and threshold setting portion 606. Once the proper threshold setting is selected, the control module 200 forwards the selected setting to the LOS setting register 408 in the PA/LD 102, as before, for use by the comparator 412 to determine whether an LOS condition exists.

Commensurate with the above, it is appreciated that a transceiver having an autonomous data rate detection functionality, such as that described above, can further enable the control module in one embodiment to modify the values contained in the data rate portion and threshold setting portion of the LOS table as may be desired or required during transceiver operation. It is further appreciated that notwithstanding its autonomous data rate detection, the transceiver can nonetheless maintain communication with the host with regard to various matters relating to the received optical signal.

The discussion presented above has focused on use of embodiments of the present invention in determining when an LOS status is present. However, embodiments of the present invention can be expanded to include the inverse of LOS, i.e., to determine when a sufficient signal exists for data transfer and to indicate this stats via a signal detect signal. Thus, this and other additional applications are contemplated are falling within the claims of the present invention.

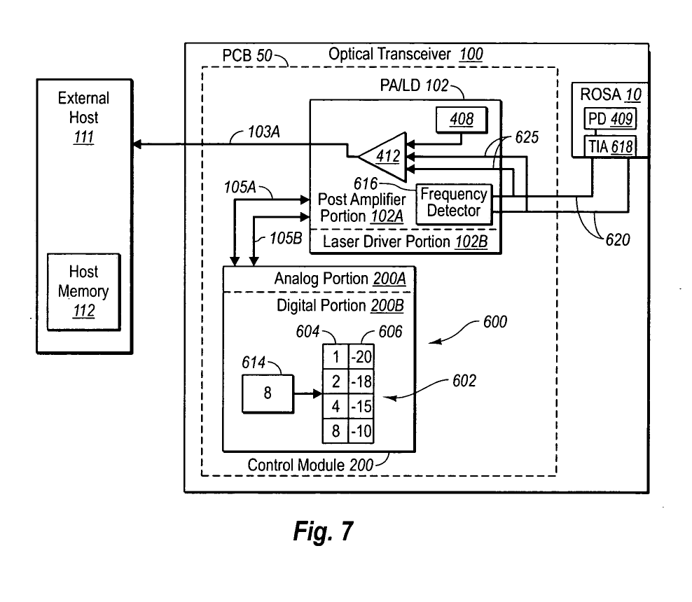

Reference is made to FIG. 7, wherein yet another embodiment of the present invention is disclosed. In other embodiments of the present invention, such as the embodiment shown in FIG. 6, evaluation of an LOS status is determined using the absolute power measurements of the received light. However, in some systems, such as Fibre Channel systems, Optical Modulation Amplitude (“OMA”) can be employed in determining LOS status in such systems. FIG. 7 is an example of one such system configured to detect an LOS status using OMA data. In this embodiment, the two differential signal lines 620 from the TIA 618 are interconnected with the frequency detector 616, as in the embodiment shown in FIG. 6. However, additional signal lines 625 branch off the signal lines 620 and feed into the comparator 412, together with the signal line extending from the LOS setting register 408. Note that the two signal lines 625 replace a signal line to the comparator 412 from the PD 409, as in previous embodiments. Thus, the comparator 412 includes three inputs in accordance with OMA operation to enable an LOS status to be determined for Fibre Channel systems. In another embodiment, it is noted that the signal lines 625 can feed directly off the TIA 618.

The present invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. An optical receiver system having a programmable signal-related threshold setting, the optical receiver system comprising:
an optical receiver that receives an optical signal;
a photodetector that senses receive power of the optical signal;
at least one memory location containing a plurality of programmed signal-related threshold settings;
a processor that selects one of the programmed signal-related threshold settings according to an input signal received by the processor; and
a comparator that compares the optical signal receive power with the selected one of the programmed signal-related threshold settings.

2. The optical receiver as defined in claim 1, wherein the programmed signal-related threshold settings correspond to a plurality of possible input signal values that each relate to a data rate of the optical signal.

3. The optical receiver as defined in claim 1, wherein the signal-related threshold setting is selected from one of the following: a loss of signal threshold setting, and a signal detect threshold setting.

4. The optical receiver as defined in claim 1, wherein the at least one memory location is composed of non-volatile memory.

5. The optical receiver as defined in claim 1, wherein the optical receiver is included in an optical transceiver module, and wherein the comparator is included in a post amplifier portion of the optical transceiver module.

6. An optical receiver system having a programmable loss of signal threshold level, the optical receiver comprising:
an optical receiver that receives an optical signal;
a photodetector that senses a receive power of the optical signal; and
a control module including:
at least one register containing a plurality of programmed loss of signal threshold settings; and
a processor containing microcode that, when executed, causes the processor to execute the following:
in response to an input signal relating to a data rate of the optical signal, select from a register a specified one of a plurality of loss of signal threshold settings; and
forward the selected loss of signal threshold setting to a comparator that compares the selected loss of signal threshold setting to at least one signal related to the optical signal.

7. The optical receiver system as defined in claim 6, wherein the at least one register includes a data rate portion including a plurality of possible data rates for the optical signal and a loss of signal threshold setting portion containing the plurality of loss of signal threshold settings.

8. The optical receiver system as defined in claim 7, further including a data rate register for containing data rate information contained in the input signal, the data rate register being in operable communication with at least one of the processor and the at least one register.

9. The optical receiver system as defined in claim 8, wherein information contained in at least one of the data rate portion, the loss of signal threshold setting portion, and the data rate register can be modified by a host system that is operably connected to the optical receiver system.

10. The optical receiver as defined in claim 6, wherein the input signal is generated by a frequency detector that determines the data rate of the optical signal, the frequency detector being included as a component in the optical receiver system.

11. The optical receiver as defined in claim 6, wherein the at least one signal related to the optical signal is selected from one of the following: the power of the sensed optical signal, and an optical modulation amplitude of the sensed optical signal.

12. A method for providing a loss of signal indication relating to an optical signal received by an optical transceiver module, the method comprising:
accessing an input signal relating to a data rate of the optical signal;
by a processor, assigning a loss of signal threshold level according to the data rate;
comparing a receive power of the optical signal with the assigned loss of signal threshold level to determine if a loss of signal condition exists; and
if a loss of signal condition exists, transmitting a loss of signal alert to a host system.

13. The method for providing as defined in claim 12, wherein the loss of signal threshold level is assigned by accessing a register containing a plurality of possible threshold levels.

14. The method for providing as defined in claim 13, wherein the register and the processor are included in a control module positioned on a printed circuit board of the optical transceiver module.

15. The method for providing as defined in claim 14, further comprising:
converting the assigned loss of signal threshold level from a digital value to an analog value.

16. The method for providing as defined in claim 15, wherein comparing the receive power further comprises:
comparing an analog receive power value to the analog loss of signal threshold level value.

17. The method for providing as defined in claim 16, wherein the input signal contains the data rate of the optical signal.

18. The method for providing as defined in claim 17, wherein accessing the input signal further includes:
accessing an input signal provided by the host system.

19. The method for providing as defined in claim 18, wherein a loss of signal condition exists when the value of the assigned loss of signal threshold level setting exceeds the value of the receive power.

20. The method for providing as defined in claim 19, wherein the data rate of the optical signal is within a range extending from approximately 1 Gbit/second to 10 Gbit/second.

21. The method for providing as defined in claim 20, wherein comparing the receive power further comprises:
by a comparator positioned in an integrated post amplifier/laser driver component, comparing the receive power with the assigned loss of signal threshold level to determine if a loss of signal condition exists.
